(19) United States
(12) Patent Application Publication
(10) Pub. No.: US 2017/0249024 A1
(43) Pub. Date: Aug. 31, 2017

(54) HAPTIC MOUSE

(71) Applicant: Apple Inc., Cupertino, CA (US)

(72) Inventors: Benjamin G. Jackson, Cupertino, CA (US); John B. Morrell, Cupertino, CA (US); Megan A. McClain, Cupertino, CA (US); Steven J. Taylor, Cupertino, CA (US); Brian T. Gleeson, Cupertino, CA (US)

(21) Appl. No.: 15/055,559

(22) Filed: Feb. 27, 2016

(51) Int. Cl. G06F 3/0354; G06F 3/01

(52) U.S. Cl. CPC G06F 3/03543; G06F 3/016; G06F 2203/014

(57) ABSTRACT

A haptic mouse is configured to provide various kinds of haptic input. In some embodiments, the mouse has first and second housing portions and an actuator operable to provide haptic output by moving the first housing portion with respect to the second housing portion so as to tangentially displace skin or alter hand posture of a user's hand. In various embodiments, the mouse has a force sensor, an actuator, and a controller operable to determine an amount of force exerted on the haptic mouse, simulate a mouse click if the amount of the force exceeds a threshold, and adjust the threshold upon receiving an instruction. In numerous embodiments, the mouse has a housing, a friction adjustment mechanism operable to alter friction between the housing and a surface by adjusting an amount of a material in contact with the surface, and a controller operable to provide a haptic output by signaling the friction adjustment mechanism.

### FIELD

The described embodiments relate generally to input devices. More particularly, the present embodiments relate to graspable input devices such as computer mice that are operable to provide various types of haptic output.

### BACKGROUND

Users provide input to computing devices or other electronic devices using a variety of different input devices. Such input devices include keyboards, computer mice, microphones, touch screens, and so on. Some input devices are incorporated into the electronic devices for which they are configured to receive input. Other input devices are separate from such electronic devices and communicate input received.

Some input devices, such as computer mice, are graspable. Computer mice are typically operable to be manipulated to control a cursor on a user interface display. The user may view the movement of the cursor on the user interface to confirm that input related to such movement has actually been received. Computer mice may also include one or more buttons. User press of such a button may compress a dome switch. The user may tactilely feel the compression of the dome switch to confirm that the button has actually been pressed.

### SUMMARY

The present disclosure relates to a haptic mouse that is configured to provide various haptic outputs to a user. The haptic mouse may provide vibrations through one or more housings or other portions, move housings or other portions with respect to each other to tangentially displace skin and/or alter a hand posture of the user's hand, adjust friction between the haptic mouse and a surface on which the haptic mouse moves, expand or contract one or more portions, combinations thereof, and so on. As such, the haptic mouse may enrich the user's experience by providing more information to the user and/or via a variety of different ways.

In various implementations, a haptic input device includes a housing, the housing having a first housing portion and a second housing portion coupled to the first housing portion, and an actuator coupled to the first housing portion or the second housing portion. The actuator is operable to provide haptic output by moving the first housing portion with respect to the second housing portion so as to tangentially displace skin or alter hand posture of a user's hand.

In some examples, the haptic input device also includes an additional actuator coupled to at least one of the first housing portion or the second housing portion. The additional actuator is operable to provide an additional haptic output by transmitting a vibration to the user's hand via one of the first housing portion or the second housing portion.

In various examples, the haptic input device also includes an expansion mechanism coupled to the first housing portion or the second housing portion. The expansion mechanism is operable to provide an additional haptic output by expanding an area of the first housing portion or the second housing portion. Such an expansion mechanism may be an air chamber. The expansion mechanism may be operable to expand a first area of the first housing portion and a second area of the second housing portion in a second direction.

In numerous examples, the first housing portion and the second housing portion are configured to simultaneously contact the user's hand during the haptic output. In various examples, the actuator is operable to move the first housing portion with respect to the second housing portion so as to alter a position of a first finger of the user's hand with respect to a second finger of the user's hand.

In some implementations, a haptic mouse includes a controller, a force sensor coupled to the controller, and an actuator coupled to the controller. The controller is operable to determine an amount of a force exerted on the haptic mouse based on a signal received from the force sensor, simulate a mouse click (which may include simulating compression of a dome switch) by providing a haptic output via the actuator if the amount of the force exceeds a threshold, and adjust the threshold upon receiving a threshold modification instruction.

In various examples, the controller receives the threshold modification instruction in response to an indication from a user to modify the threshold. In other examples, the controller receives the threshold modification instruction in response to a status change of an electronic device with which the haptic mouse communicates. In numerous examples, the controller is operable to simulate a first mouse click by providing a first haptic output via the actuator if the amount of the force exceeds a first threshold, and simulate a second mouse click by providing a second haptic output via the actuator if the amount of the force exceeds a second threshold.

In some examples, the haptic mouse further includes a housing coupled to the actuator. In such examples, the actuator operable to provide a first vibration via a first area of the housing, and a second vibration via a second area of the housing. The actuator may include a first actuator operable to provide the first vibration and a second actuator operable to provide the second vibration and the haptic mouse may further include a dampener coupled to the housing between the first actuator and the second actuator. The dampener is operable to shield the first area from the second vibration and operable to shield the second area from the first vibration.

In various examples, the force sensor and the actuator are a single piezoelectric element. The piezoelectric element is operable to produce a signal indicative of the amount of force exerted on the piezoelectric element when the force is exerted on the piezoelectric element and to produce the haptic output when a voltage is applied to the piezoelectric element.

In numerous implementations, a haptic mouse includes a housing, a friction adjustment mechanism coupled to the housing operable to alter friction between the housing and a surface by adjusting an amount of a material in contact with the surface, and a controller coupled to the friction adjustment mechanism. The controller is operable to provide a haptic output by signaling the friction adjustment mechanism.

In some examples, the friction adjustment mechanism includes a rubber foot having a variable surface area that contacts the surface. A portion of the rubber foot may be operable to extend from the housing and retract into the housing.

In various examples, the friction adjustment mechanism includes an actuator operable to provide a vibration to a portion of the housing that contacts the surface. The vibration may be an ultrasonic vibration. In such examples, the actuator may increase a frequency of the vibration to decrease the friction and/or decrease the frequency of the vibration to increase the friction.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 depicts a system for providing output via a haptic mouse.

FIG. 2 depicts a schematic diagram of a first example haptic mouse that may be used in the system of FIG. 1.

FIG. 3 depicts a schematic diagram of a second example haptic mouse that may be used in the system of FIG. 1.

FIG. 4 depicts a schematic diagram of a third example haptic mouse that may be used in the system of FIG. 1.

FIG. 5A depicts a first example of movement of a first portion of an example haptic mouse with respect to a second portion. Such a haptic mouse 501 may be the third example haptic mouse 401 of FIG. 4.

FIG. 5B depicts a second example of movement of the first portion of the example haptic mouse of FIG. 5A with respect to the second portion.

FIG. 5C depicts a third example of movement of the first portion of the example haptic mouse of FIG. 5A with respect to the second portion.

FIG. 6 depicts a schematic diagram of a fourth example haptic mouse that may be used in the system of FIG. 1.

FIG. 7A depicts a first example of expansion of a first portion of an example haptic mouse. Such an example haptic mouse may be the fourth example haptic mouse of FIG. 6.

FIG. 7B depicts a second example of expansion of the first portion of the example haptic mouse of FIG. 7A.

FIG. 8A depicts a side view of a fifth example of a haptic mouse that may be used in the system of FIG. 1.

FIG. 8B depicts a top view of the fifth example of a haptic mouse of FIG. 8A.

FIG. 8C depicts a cross-sectional view of an example implementation of the fifth example of a haptic mouse of FIG. 8B, taken along line A-A of FIG. 8B.

FIG. 9 depicts a flow chart illustrating a first example method for providing output via a haptic mouse. This example method may be performed by one or more of the haptic mice of FIGS. 1-8C.

FIG. 10 depicts a flow chart illustrating a second example method for providing output via a haptic mouse. This example method may be performed by one or more of the haptic mice of FIGS. 1 and 4-7B.

FIG. 11 depicts a flow chart illustrating a third example method for providing output via a haptic mouse. This example method may be performed by one or more of the haptic mice of FIGS. 1 and 8A-8C.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, methods, and apparatuses that embody various elements of the present disclosure. However, it should be understood that the described disclosure may be practiced in a variety of forms in addition to those described herein.

The following disclosure relates to a haptic mouse or other graspable input device. The haptic mouse is configured with components that provide a variety of different haptic outputs to a user. Such haptic outputs may include high frequency/low displacement vibrations provided through one or more housings or other portions, portions that move with respect to other portions to affect a user's skin (e.g., exerting pressure or normal force on the user's skin, compressing the user's skin, displacing the user's skin in a normal direction, tangentially displace skin, and so on) and/or alter a hand posture of the user's hand (the position of parts of the user's hand in with respect to other parts of the user's hand, such as the height of the tip of the user's finger with respect to the base of the user's hand, the amount of bend in the user's finger, the distance between the user's fingertips of fingers, and so on), friction adjusted between the haptic mouse and a surface on which the haptic mouse moves, expansion or contraction of one or more portions, and so on. As such, the user's experience using the haptic mouse may be enriched by allowing more information to be provided to the user and/or via a variety of different ways.

In various embodiments, the haptic mouse has first and second housing portions and an actuator operable to provide haptic output by moving the first housing portion with respect to the second housing portion so as to tangentially displace skin or alter hand posture of a user's hand. In numerous embodiments, the haptic mouse has a force sensor, an actuator, and a controller operable to determine an amount of a force exerted on the haptic mouse, simulate a mouse click if the amount of the force exceeds a threshold, and adjust the threshold upon receiving an instruction. In various embodiments, the haptic mouse has a housing, a friction adjustment mechanism operable to alter friction between the housing and a surface by adjusting an amount of a material in contact with the surface, and a controller operable to provide a haptic output by signaling the friction adjustment mechanism.

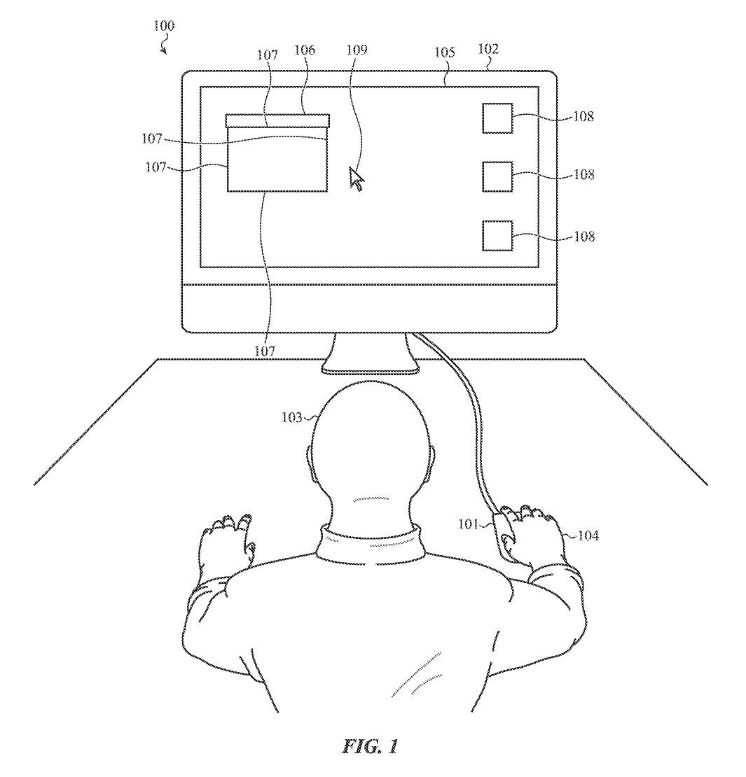

These and other embodiments are discussed below with reference to FIGS. 1-11. However, those skilled in the art will readily appreciate that the detailed description given herein with respect to these Figures is for explanatory purposes only and should not be construed as limiting.

FIG. 1 depicts a system 100 for providing output via a haptic mouse 101. The haptic mouse 101 may be operable to provide a variety of different haptic outputs to a user 103 that the user 103 may perceive via the user's hand 104. For example, as elaborated below, the haptic mouse 101 may be operable to provide various high frequency/low displacement vibrations through one or more portions of the haptic mouse 101 to the user's hand 104, move one or more portions of the haptic mouse 101 with respect to other portions in one or more directions to affect skin of the user's hand 104 and/or alter a hand posture of the user's hand 104, adjust friction between the haptic mouse 101 and a surface, expand or contract one or more portions of the haptic mouse 101, and so on. The haptic mouse 101 may be operable to provide such haptic output to provide information to the user 103 regarding any or all of various statuses of the haptic mouse 101, an electronic device 102 with which the haptic mouse 101 is configured to communicate, and so on. In this way, the user's 103 experience may be enriched by allowing more information to be provided to the user 103 and/or via a greater number of modalities.

Affecting skin of the user's hand 104 may include exerting pressure or normal force on the user's skin, compressing the user's skin, displacing the user's skin in a normal direction, tangentially displace skin, and so on. Tangentially displacing skin of the user's hand 104 (e.g., skin shear) may include expansion or contraction of the skin of the user, such as stretching of the user's skin, compression of the user's skin, pinching of the user's skin, and so on. Altering a hand posture of the user's hand 104 may include altering the position of parts of the user's hand 104 in with respect to other parts of the user's hand 104. Examples include the height of the tip of the user's finger with respect to the base of the user's hand 104, the amount of bend in the user's finger, the distance between the user's fingertips of fingers, and so on.

For example, the haptic mouse 101 may provide haptic output in response to user input. The haptic mouse 101 may include one or more force sensors that produce signals indicative of an amount of force applied by the user 103. In response to detection that such applied force exceeds one or more thresholds, the haptic mouse 101 may produce one or more haptic outputs indicating received input corresponding to the applied force. Such haptic output may simulate a mouse click (such as by simulating activation of a dome or other switch typically associated with a mouse button being pressed).

In various implementations of such an example, the force thresholds may be adjustable. For example, the user 103 may provide input to alter the thresholds and thus how much force the user has to apply before the haptic mouse 101 provides the haptic output to simulate the various mouse clicks. In another example, the electronic device 102 may provide an indication to alter the thresholds and thus how much force the user has to apply before the haptic mouse 101 provides the haptic output to simulate the various mouse clicks. The electronic device 102 may provide such an indication based on a status of the electronic device 102, in response to interaction with the user 103, and so on. For example, the electronic device 102 may indicate to increase the thresholds when the user 103 is using the haptic mouse 101 to delete a file 108 as compared to moving the file 108 around the user interface 105 in order to communicate to the user 103 the severity of the delete action through the increased force required on the haptic mouse 101 to cause the file 108 to be deleted.

By way of another example, the haptic mouse 101 may provide haptic output to indicate information about events related to the electronic device 102. The haptic mouse 101 may provide haptic output to indicate status changes of the electronic device 102, such as providing a vibration upon receipt of an incoming communication such as an email. The haptic mouse 101 may also provide haptic input based on interaction between the user 103 and the electronic device 102.

For example, the haptic mouse 101 may move one or more portions of the haptic mouse 101 with respect to other portions in one or more directions to affect skin of the user's hand 104 and/or alter a hand posture of the user's hand 104 when the user 103 uses the haptic mouse 101 to move a cursor 109 on a user interface 105 presented by the electronic device 102 across a border 107 of a graphical element such as a window 106. In such an example, the haptic mouse 101 may move the portion of the haptic mouse 101 in the opposite direction that the cursor 109 travels to move over the border 107. This may stretch the skin (tangentially deflecting the skin or altering the skin shear) of the user's hand 104 and/or increase a distance between two of the fingers (altering a hand posture) of the user's hand 104 in a way that simulates the haptic mouse 101 striking a physical object from the direction that the cursor 109 traveled over the border 107.

By way of another example, the haptic mouse 101 may adjust friction between the haptic mouse 101 and a surface on which the haptic mouse 101 is operable to move to indicate a data size of a file 108 when the user 103 is moving the haptic mouse 101 to instruct moving of the file 108 on the user interface 105. For example, the haptic mouse 101 may lower friction below a normal friction level when the file 108 being moved is smaller than average (such as 100 kilobytes), increase friction above the normal friction level when the file 108 being moved is larger than average (such as 500 megabytes), and so on.

It is understood that the above discussion of haptic outputs provided by the haptic mouse 101 are examples. In various implementations, the haptic mouse 101 may provide a variety of different haptic outputs in a variety of different situations in order to enrich the user's 103 experience with the haptic mouse 101 and/or the electronic device 102. Various examples are discussed in more detail below.

The haptic mouse 101 is described as including one or more force sensors in some embodiments. These force sensors may be any kind of sensor that can be used to directly or indirectly determine or estimate force applied to the haptic mouse 101. These force sensors may include capacitive force sensors, piezoelectric force sensors, strain gauges, accelerometers, acoustic sensors, and/or various other kinds of sensors. These sensors may measure force directly applied, measure displacement or deformation of a housing or other portion, measure strain in a housing or other portion, optically detect deformation of a housing or other portion, detect net force-torque of the haptic mouse 101 with respect to a surface, and so on.

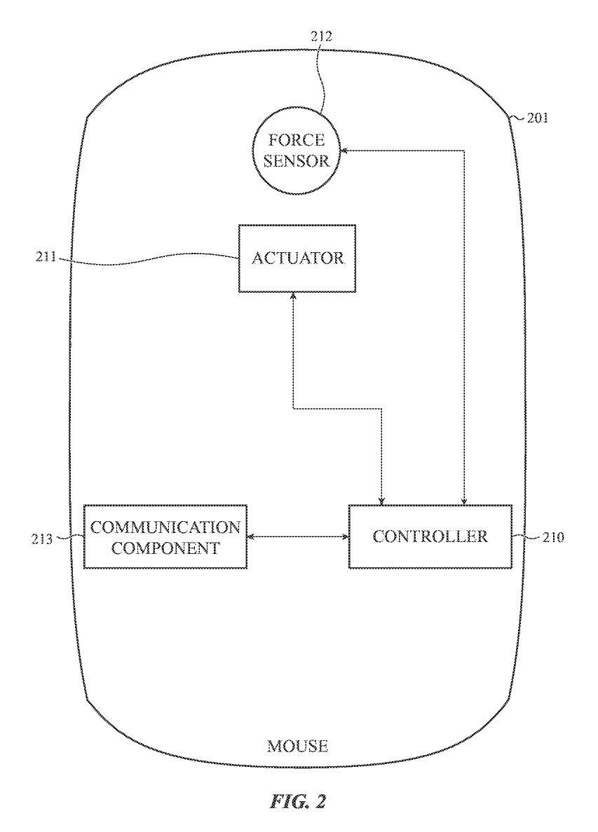

FIG. 2 depicts a schematic diagram of a first example haptic mouse 201 that may be used in the system 100 of FIG. 1. The haptic mouse 201 may include one or more controllers 210 (such as a processing unit), communication components 213 (such as wired and/or wireless communication components 213 that exchange data with an electronic device such as the electronic device of FIG. 1), actuators 211, and force sensors 212. The controller 210 may receive one or more signals from the force sensor indicative of an amount of force exerted on the haptic mouse 201. The controller 210 may control the actuator 211 to transmit one or more vibrations to the hand or other body part of a user via one or more portions of the haptic mouse 201, such as a housing portion. The controller 210 may control the actuator 211 to transmit such vibrations based on force applied to the haptic mouse 201 that the controller 210 determines using the force sensor 212.

For example, the controller 210 may control the actuator 211 to simulate a first mouse click by providing a first haptic output via the actuator 211 if the amount of the force meets or exceeds a first threshold (such as a first force threshold), simulate a second mouse click by providing a second haptic output via the actuator 211 if the amount of the force meets or exceeds a second threshold (such as a second force threshold), and so on. The first and second haptic outputs may differ from one another, such as having different amounts of force, different vibration patterns, and so on.

In various implementations, the controller 210 may be operable to adjust the thresholds. The controller 210 may adjust one or more thresholds based on input from a user, instructions received from an electronic device with which the haptic mouse 201 communicates, and so on. In this way, the haptic mouse 201 may be operable to modulate the force used by a user to trigger input, the mouse clicks and/or other outputs provided to a user, and so on.

For example, the controller 210 may determine an amount of a force exerted on the haptic mouse 201 based on a signal received from the force sensor 212, simulate a mouse click (which may include simulating compression of a dome switch) by providing a haptic output via the actuator 211 if the amount of the force exceeds a threshold, and adjust the threshold upon receiving a threshold modification instruction. The controller 210 may receive the threshold modification instruction in response to an indication from a user to modify the threshold, a status change of a computing device or other electronic device with which the haptic mouse 201 communicates, and so on.

The force sensor 212 may be one or more of a variety of different sensors. In some implementations, the force sensor 212 may include a pair of capacitive plates separated by a dielectric (such as silicone, foam, air, and so on) to form a capacitor. Movement of the capacitive plates under the exertion of force may alter the position of the capacitive plates with respect to each other and thus the capacitance of the capacitor. Signals received from the force sensor 212 may indicate the capacitance of the capacitor and may be correlated (such as using a lookup table, estimation, and so on) to determine the applied force.

The actuator 211 may be a variety of different actuators operable to transmit force via portions of the haptic mouse 201 such as a housing portion. Such actuators may include high frequency/low displacement actuators such as piezoelectric materials operable to deform and/or otherwise produce vibration (or other tactile outputs) when electrical current is applied.

Although the haptic mouse 201 is illustrated and described as including particular components arranged in a particular configuration, it is understood that this is an example. In various implementations, various configurations of the same, similar, and/or different components may be utilized without departing from the scope of the present disclosure.

For example, in various implementations, the haptic mouse 201 may include one or more non-transitory storage media (which may take the form of, but is not limited to, a magnetic storage medium; optical storage medium; magneto-optical storage medium; read only memory; random access memory; erasable programmable memory; flash memory; and so on). The controller 210 may execute instructions stored in the non-transitory storage medium to perform various haptic mouse 201 operations.

By way of another example, the force sensor 212 and the actuator 211 are illustrated and described as separate components. However, in some implementations, these components may be integrated into a single combined force sensor/actuator. For example, the force sensor 212 and the actuator 211 may be a single piezoelectric element. The piezoelectric element may be operable to produce a signal (such as a voltage) indicative of an amount of force exerted on the piezoelectric element when force is exerted (which may deform the piezoelectric element) on the piezoelectric element. Such a signal may be correlated to determine the force exerted. The piezoelectric element may also be operable to produce a haptic output (such as a vibration) when voltage and/or current is applied (which may deform the piezoelectric element).

By way of still another example, the actuator 211 is illustrated and described as transmitting one or more vibrations to the hand or other body part of a user via one or more portions of the haptic mouse 201. In some implementations, the actuator 211 may provide haptic output by transmitting ultrasonic vibrations via such portions of the haptic mouse 201. Such ultrasonic vibrations may alter friction between the haptic mouse 201 and the hand of the user. This change in friction may be perceptible to the user, indicating various information to the user about a status of the haptic mouse 201, a status of an electronic device with which the haptic mouse 201 communicates, and so on. Further, in addition to manipulating friction using ultrasonic vibrations, electrostatic forces between the haptic mouse 201 and the hand of the user may be manipulated to alter friction.

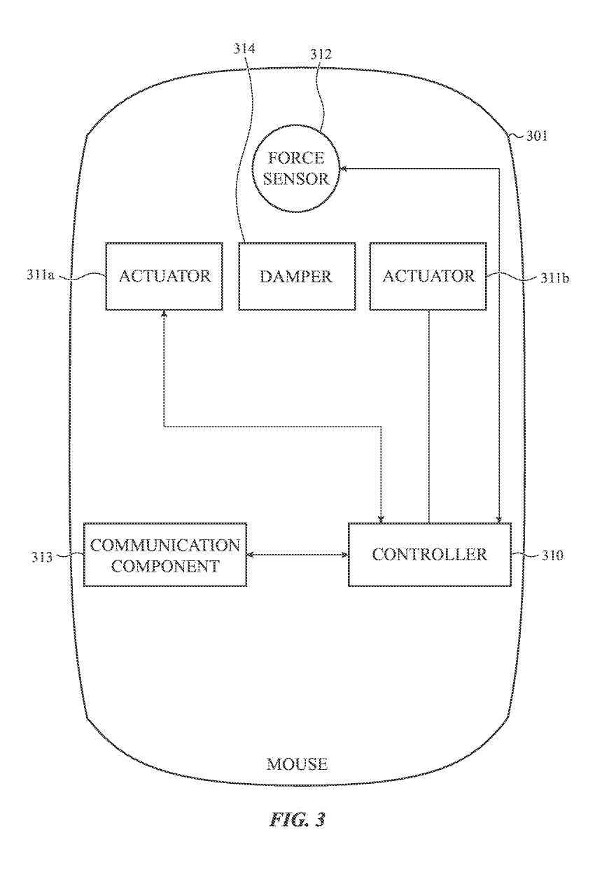

FIG. 3 depicts a schematic diagram of a second example haptic mouse 301 that may be used in the system 100 of FIG. 1. The haptic mouse 301 may include one or more controllers 310, communication components 313, and force sensors 312. The haptic mouse 301 may also include multiple actuators 311a, 311b that are separated by one or more dampeners 314 (which may be coupled to a housing between a first actuator 311a and a second actuator 311b). The controller 310 may control the actuators 311a, 311b to transmit one or more vibrations to the hand or other body part of a user via a portion of the haptic mouse 301, such as a housing portion. The dampener 314 may operate as a shield between the actuators 311a, 311b, preventing or reducing the spread of vibrations produced by each. Thus, due to the dampener 314 being coupled to the portion between the actuators 311a, 311b, the actuator 311a may be operable to transmit vibrations to a first area of the portion without vibrating a second area of the portion to which the actuator 311b is operable to transmit vibrations despite both of the actuators 311a, 311b being connected to the same portion, and vice versa. This may allow the haptic mouse 301 to produce haptic output in localized areas without connecting the actuators 311a, 311b to distinct portions of the haptic mouse 301.

For example, a first actuator 311a may be operable to provide a first vibration via a first area of a housing and a second actuator 311b may be operable to provide a second vibration via a second area of the housing. The dampener 314 may be operable to shield the first area from the second vibration and shield the second area from the first vibration.

In various implementations, the dampener 314 may be a material that absorbs vibrations, such as rubber, foam, shock absorber assemblies, and so on. In other implementations, the dampener 314 may itself be a component that produces vibrations. In such other implementations, the vibrations produced by the dampener 314 may be configured to negate the vibrations produced by the actuators 311a, 311b and thus prevent or reduce spread of the vibrations produced by the actuators 311a, 311b outside the respective areas of the portion of the haptic mouse 301.

Although the haptic mouse 301 is illustrated and described as coupling the actuators 311a, 311b and the dampener 314 to the same portion of the haptic mouse 301, it is understood that this is an example. In various implementations, the haptic mouse 301 may include separate portions to which the actuators 311a, 311b are coupled. In some examples of such implementations, the dampener 314 may be omitted.

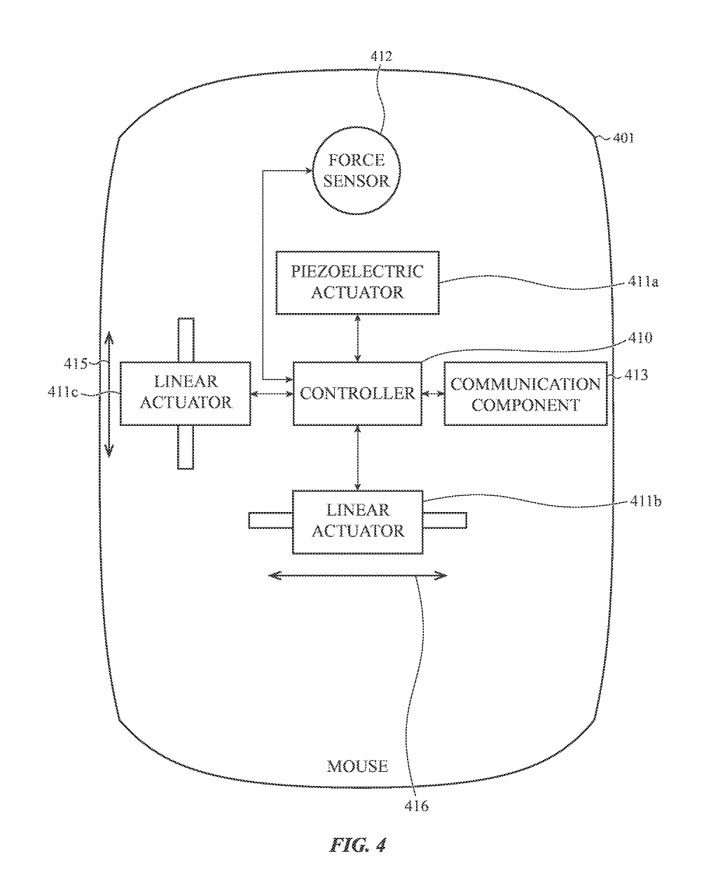

FIG. 4 depicts a schematic diagram of a third example haptic mouse 401 that may be used in the system 100 of FIG. 1. The haptic mouse 401 may include one or more controllers 410, communication components 413, piezoelectric actuators 411a (which may be coupled to one or more housings or other portions), and force sensors 412 (which may be coupled to one or more housings or other portions). The piezoelectric actuator 411a may be operable to provide haptic output by transmitting a vibration (such as a high frequency/low displacement vibration) to a user's hand via a portion of the haptic mouse 401 (such as a housing portion). The controller 410 may signal the piezoelectric actuator 411a to transmit such vibrations based on force applied to the haptic mouse 401, which may be determined using the force sensor 412. The haptic mouse 401 may also include one or more linear actuators 411b, 411c coupled to one or more housings or other portions that are operable to provide additional haptic output by moving one or more portions of the haptic mouse 401 (such as a housing portion) with respect to another portion of the haptic mouse 401. The portions moved by the linear actuators 411b, 411c may tangentially deflect skin of a user's hand contacting such portions and/or alter the hand posture of the user's hand.

Users may be capable of perceiving small differences in tangentially skin deflection or skin shear (e.g., expansion or contraction of the skin of the user, such as stretching of the user's skin, compression of the user's skin, pinching of the user's skin, and so on) and/or hand posture (e.g., the position of parts of the user's hand in with respect to other parts of the user's hand, such as the height of the tip of the user's finger with respect to the base of the user's hand, the amount of bend in the user's finger, the distance between the user's fingertips of fingers, and so on), including the direction of such motion. As such, the haptic mouse 401 may be capable of providing a large variety of different haptic inputs that are uniquely discernible by users to communicate a wide variety of information. In some cases, the first portion that is moved by one or more of the linear actuators 411b, 411c may contact a first portion of the user's hand (such as a finger) while the second portion with respect to which the first portion is moved may contact another portion of the user's hand (such as the palm). Situations where the user's hand contacts both moving and non-moving portions of the haptic mouse 401 may increase tangential skin deflection and/or hand posture over situations where the user's hand contacts the moving portion but not the non-moving portion as the skin may stretch more and/or the hand may change posture more from smaller movements of the moving portion.

Further, the high frequency/low displacement vibrations transmitted to the user's hand by the piezoelectric actuator 411a may be distinguishable to users over the tangential skin deflection/hand posture alterations resulting from the movement of the portions caused by the linear actuators 411b, 411c. As such, use of both the piezoelectric actuator 411a and the linear actuators 411b, 411c may allow the haptic mouse 401 to produce a greater variety of different haptic outputs that are uniquely perceptible to a user, particularly over implementations that utilize the piezoelectric actuator 411a alone for haptic output and produce different haptic outputs by applying different waveforms to the piezoelectric actuator 411a.

For example, the haptic mouse 401 may include a housing with a top portion and a bottom portion. The linear actuator 411b may be operable to move a mass (which may produce low frequency/high displacement vibrations) in a direction 416 in order to move the top portion with respect to the bottom portion in the direction 416. Similarly, the linear actuator 411c may be operable to move a mass in a direction 415 in order to move the top portion with respect to the bottom portion in the direction 415. The linear actuators 411b, 411c may be coupled to such portions and/or otherwise operable to move such portions by moving the respective masses. In this way, the linear actuators 411b, 411c can provide haptic output by moving the top and/or bottom portions in multiple directions 415, 416.

Although the linear actuators 411b, 411c are illustrated and described as moving portions of the haptic mouse 401, it is understood that this is simplified for the purposes of clarity. In various implementations, the linear actuators 411b, 411c may produce vibrations that displace such portions from an original position for a small period of time before the portions return to the original position.

The haptic mouse 401 is illustrated and described as including a particular number of linear actuators 411b, 411c that are operable to move portions of the haptic mouse 401 in a particular number of directions. However, it is understood that this is an example. In other implementations, other numbers of linear actuators and/or other components capable of causing movement may be used to move a variety of different portions in a variety of different directions.

Further, although the linear actuators 411b, 411c are illustrated and described as linear actuators, it is understood that this is an example. In various implementations, the linear actuators 411b, 411c may be other kinds of actuators without departing from the scope of the present disclosure. Rotational actuators, cam systems, and/or other kinds of actuators may be used.

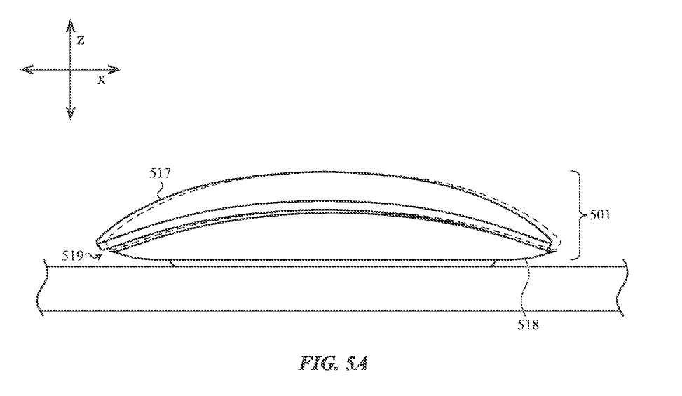

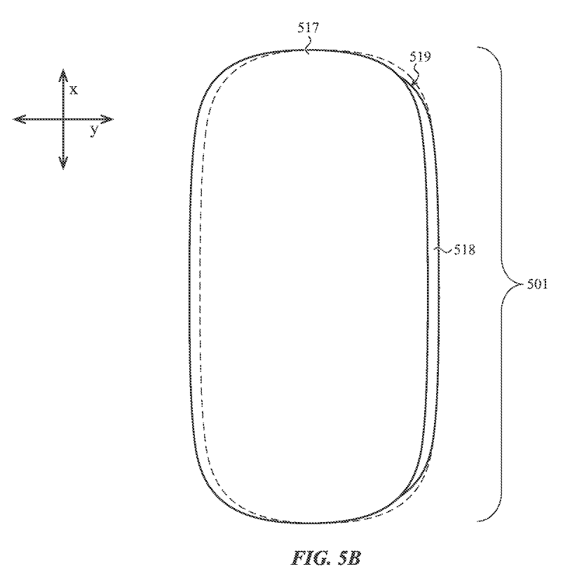

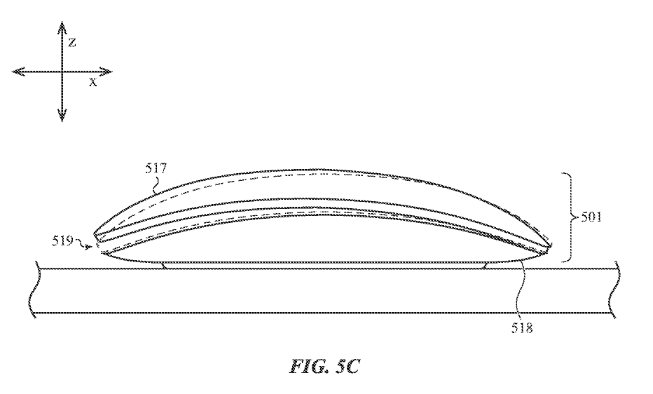

FIG. 5A depicts a first example of movement of a first portion 517 of an example haptic mouse 501 (shown from the side) with respect to a second portion 518. Such an example haptic mouse 501 may be the third example haptic mouse 401 of FIG. 4. In this example, the first portion 517 is a top portion of a housing that is coupled to and operable to move with respect to a second portion 518 that is a bottom portion of the housing. As shown, the first portion 517 moves in an X direction (from an original position shown in phantom) with respect to the second portion 518 (shown as left with respect to FIG. 5A) to create a gap 519. The X direction shown in FIG. 5A may correspond to the direction 415 shown in FIG. 4. Such movement of the first portion 517 in the X direction may tangentially deflect skin of one or more of a user's fingers, alter a position of the user's fingers with respect to each other and/or the base of the user's hand, and so on.

FIG. 5B depicts a second example of movement of the first portion 517 of the example haptic mouse 501 of FIG. 5A (shown from the top) with respect to the second portion 518. As shown, the first portion 517 moves in a Y direction (from an original position shown in phantom) with respect to the second portion 518 (shown as left with respect to FIG. 5B) to create the gap 519. The Y direction shown in FIG. 5B may correspond to the direction 416 shown in FIG. 4. Such movement of the first portion 517 in the Y direction may tangentially deflect skin and/or the posture of the user's palm and so on.

FIG. 5C depicts a third example of movement of the first portion 517 of the example haptic mouse 501 of FIG. 5A (shown from the side) with respect to the second portion 518. As shown, the first portion 517 moves in a Z direction (from an original position shown in phantom, essentially “popping up”) with respect to the second portion 518 (shown as up with respect to FIG. 5C) to create the gap 519. Such movement of the first portion 517 in the Z direction may tangentially deflect skin of one or more of a user's fingers, alter a position of the user's fingers with respect to each other and/or the base of the user's hand, and so on.

Thus, with reference to FIGS. 5A-5C, the example haptic mouse 501 may utilize two portions operable to move with respect to each other to provide a variety of different haptic output. However, although a particular number of portions moving in a particular number of directions is illustrated and described above, it is understood that this is an example. In various implementations, various numbers of portions may be moved in various directions with respect to other portions without departing from the scope of the present disclosure.

For example, in some implementations, the second portion 518 may be moved instead of the first. In other implementations, one or more of the first and second portions 517, 518 may include any number of different portions that may be moved independently. By way of example, in some implementations the second portion 518 may include one or more side portions that are movable with respect to the first portion 517. Various configurations are possible and contemplated.

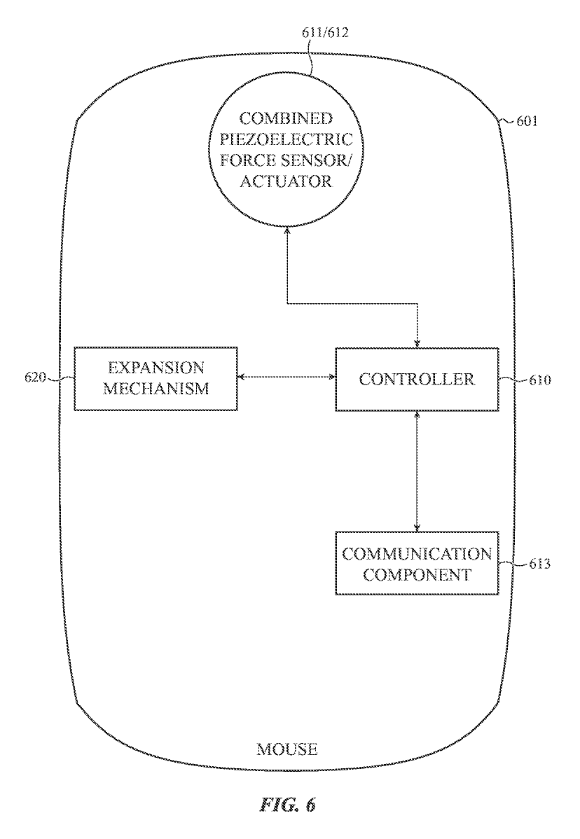

FIG. 6 depicts a schematic diagram of a fourth example haptic mouse 601 that may be used in the system 100 of FIG. 1. The haptic mouse 601 may include one or more controllers 610, communication components 613, and combined piezoelectric actuator force sensors 611/612 (such as a piezoelectric element that is operable to produce a voltage when deformed under the exertion of force and is operable to deform to produce a vibration or other haptic output when current is applied). The haptic mouse 601 may also include one or more expansion mechanisms 620 that are operable to provide haptic output by expanding and/or contracting one or more portions, and/or areas of such portions, of the haptic mouse 601.

The expansion mechanism 620 may be any mechanism operable to exert pressure to deform the portion of the haptic mouse 601 to cause expansion and/or allow contraction. For example, the expansion mechanism 620 may be an air chamber or bladder that is operable to inflate and/or deflate in order to exert pressure to deform the portion of the haptic mouse 601. By way of another example, the expansion mechanism 620 may be a servo motor that is operable to extend and/or retract in order to exert pressure to deform the portion of the haptic mouse 601. By way of still another example, the expansion mechanism 620 may be a piezoelectric material that is operable to deform when current is applied in order to exert pressure to deform the portion of the haptic mouse 601.

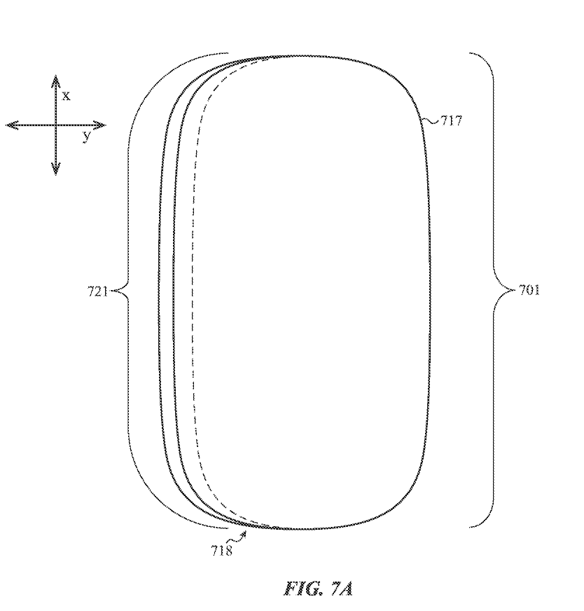

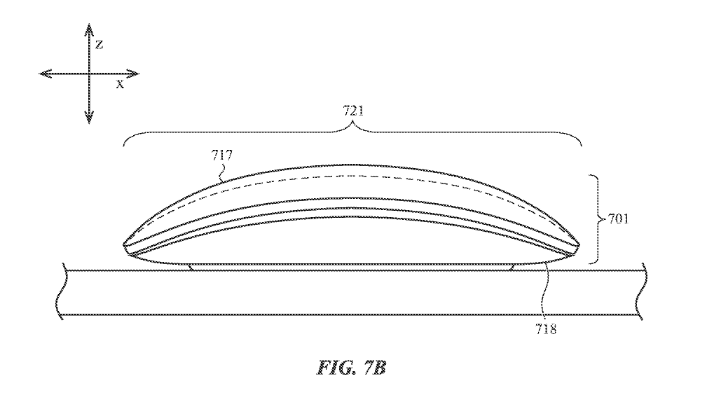

FIG. 7A depicts a first example of expansion of a first portion 717 of an example haptic mouse 701 (shown from the top). Such an example haptic mouse 701 may be the fourth example haptic mouse 601 of FIG. 6. In this example, the haptic mouse 701 includes a first portion 717 that is a top portion and a second portion 718 that is a bottom portion. Further in this example, the first and/or second portions 717, 718 may be expandable by an expansion mechanism of the haptic mouse 701. As shown, a side (left with respect to FIG. 7A) of the second portion 718 is shown expanded (from an original position shown in phantom) in a Y direction to create a bulge 721. Such expansion of the second portion 718 in the Y direction may press against a portion of the user's hand and thus be perceptible to the user as haptic output.

FIG. 7B depicts a second example of expansion of the first portion 717 of the example haptic mouse 701 of FIG. 5A (shown from the side). As shown, the top portion 817 (left with respect to FIG. 7A) is shown expanded (from an original position shown in phantom) in a Z direction to create the bulge 721. Such expansion of the first portion 717 in the Z direction may press against a portion the user's hand and thus be perceptible to the user as haptic output.

Although a particular number of expandable portions are illustrated and described above, it is understood that this is an example. In various implementations, various numbers of portions may be expanded in various amounts in various directions without departing from the scope of the present disclosure.

For example, in some implementations, one of the first or second portions 717, 718 may be configured to expand while the other is not. Further, although an entire surface of the first and second portions 717, 718 is illustrated as expanding, in some implementations such expansion may be confined to localized areas of such surfaces. An expansion mechanism may be operable to expand a first area of the first or second portions 717, 718 in a first direction, a second area of the first or second portions 717, 718 in a second direction, and so on.

In some implementations, the first or second portions 717, 718 may be configured to simultaneously contact a user's hand during use of the haptic mouse 701. A linear and/or other actuator may be operable to move one of the first or second portions 717, 718 with respect to the other so as to alter a position of a first finger of a user's hand with respect to a second finger (or thumb) of the user's hand. Various configurations are possible and contemplated.

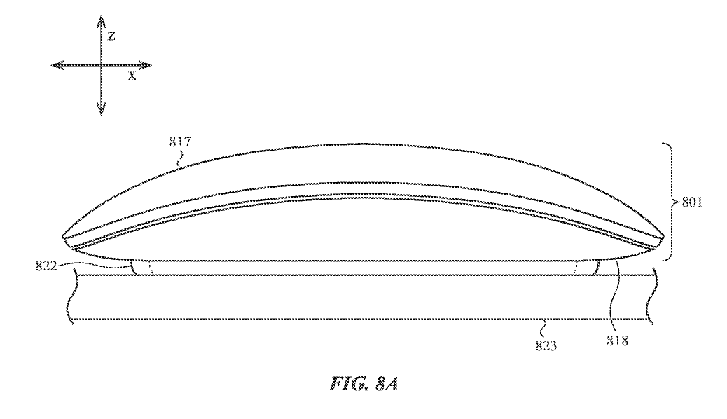

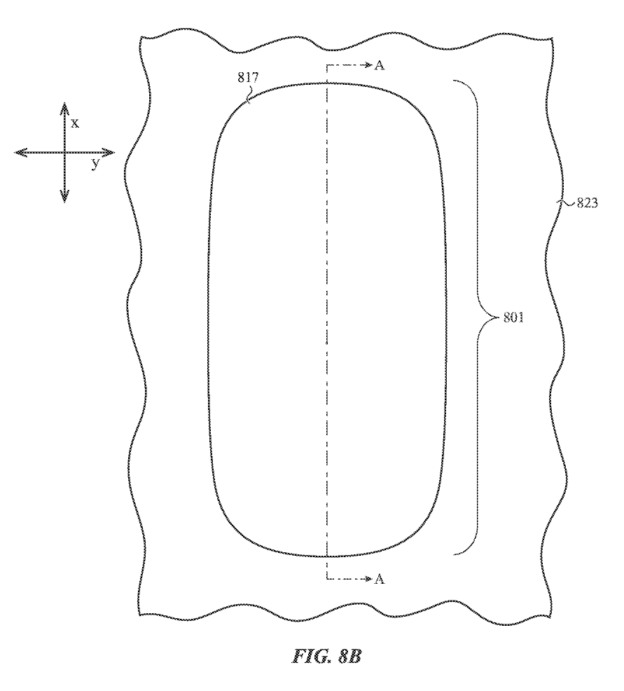

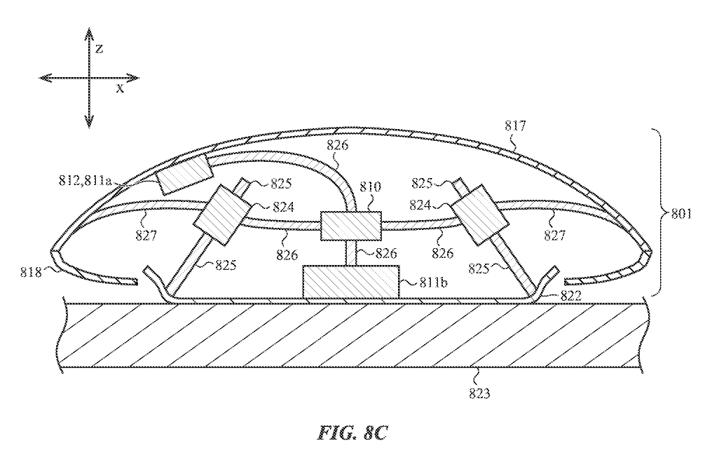

FIG. 8A depicts a side view of a fifth example of a haptic mouse 801 that may be used in the system 100 of FIG. 1. The haptic mouse 801 may include a housing including a first or top portion 817 coupled to a second or bottom portion 818. The haptic mouse 801 may also include a friction adjustment mechanism 822 (which may be coupled to the housing) that is operable to alter friction between the housing of the haptic mouse 801 and a surface 823 on which the haptic mouse 801 is configured to move by adjusting an amount of material in contact with the surface 823. As shown, the friction adjustment mechanism 822 is implemented as including a rubber foot which has a variable surface area (shown as adjusted to a larger surface area with a smaller surface area shown in phantom) that contacts the surface 823. Adjusting the friction between the housing of the haptic mouse 801 may make the haptic mouse 801 moveable by the user using differing amounts of force. Adjusting the force used by the user to move the haptic mouse 801 may convey haptic output to the user.

For example, the friction adjustment mechanism 822 may lower friction below a normal friction level when a file being moved on a user interface is smaller than a first threshold amount (such as 50 kilobytes), increase friction above the normal friction level when the file being moved is larger than average (such as one gigabyte), and so on. The haptic mouse 801 may communicate with an electronic device that is presenting the user interface as part of such operations.

FIG. 8B depicts a top view of the fifth example of a haptic mouse 801 of FIG. 8A. As shown, in some implementations the friction adjustment mechanism 822 may not be visible to a user when the haptic mouse 801 is viewed from the top regardless of the amount of material in contact with the surface 823. Keeping the friction adjustment mechanism 822 out of user view may be more aesthetically pleasing to users.

FIG. 8C depicts a cross-sectional view of an example implementation of the fifth example of a haptic mouse 801 of FIG. 8B, taken along line A-A of FIG. 8B. In this implementation, the variable surface area of the rubber foot of the friction adjustment mechanism 822 may be controlled by motors 824 (connected to a controller 810 that is operable to provide a haptic output by signaling the friction adjustment mechanism 822 in order to control the motors 824 via flex circuits 826 and/or other electrical connections) that are operable to extend and retract pistons 825. In this way, portions of the rubber foot may be operable to extend from a housing and/or retract into the housing.

The motors 824 may be coupled to the bottom portion 818 and/or portions of the haptic mouse 801 via supports 827. Extension of the pistons 825 may force ends of the rubber foot out of the housing such that the rubber foot has a larger surface area in the X and/or Y directions (and thus more friction between the housing and the surface 823). Retraction of the pistons 825 may retract the ends of the rubber foot into the housing such that the rubber foot has a smaller surface area in the X and/or Y directions (and thus less friction between the housing and the surface 823).

The haptic mouse 801 (and/or the friction adjustment mechanism 822) may also include an actuator 811b (connected to the controller 810 via a flex circuit 826 and/or other electrical connection) coupled to a portion of the housing such as the rubber foot. The actuator 811b may be operable to provide a vibration such as an ultrasonic vibration to a portion of the housing that contacts the surface 823. This may vary the amount of the material of the portion of the housing in contact with the surface 823, such as by causing the haptic mouse 801 to bounce on the surface 823. The actuator 811b may increase the frequency of the vibration to decrease the friction between the haptic mouse 801 and the surface 823. Similarly, the actuator 811b may decrease the frequency of the vibration to increase the friction between the haptic mouse 801 and the surface 823.

Although the above describes adjusting friction between the haptic mouse 801 and the surface 823 using ultrasonic vibrations, it is understood that this is an example. In some implementations, electrostatic forces between the between the haptic mouse 801 and the surface 823 may be manipulated to alter friction.

In some implementations, the haptic mouse 801 may also include one or more piezoelectric actuators 811a, force sensors 812, and/or combined piezoelectric actuator/force sensors 811a/812 (such as a piezoelectric element that is operable to produce a voltage when deformed under the exertion of force and is operable to deform to produce a vibration or other haptic output when current is applied) coupled to a portion of the haptic mouse 801 (such as the top portion 817) operable to transmit vibrations to a user via the portion. Such piezoelectric actuators 811a/force sensors 812 may be connected to the controller 810 via a flex circuit 826 and/or other electrical connection. The piezoelectric actuators 811a/force sensors 812 and the friction adjustment mechanism 822 may allow the haptic mouse 801 to provide a variety of different kinds of haptic output to a user.

Although the haptic mouse 801 is illustrated and described as including particular components configured in various arrangements in FIGS. 8A, 8B, and/or 8C, it is understood that these are examples. In various implementations, other configurations of the same, similar, and/or different components may be used without departing from the scope of the present disclosure.

For example, the haptic mouse 801 is illustrated and described as the friction adjustment mechanism 822 is implemented as a rubber foot which has a variable surface area that contacts the surface 823. However, in other implementations, various friction adjustment mechanisms 822 that alter friction between the housing of the haptic mouse 801 and the surface 823 may be used. By way of example, in various implementations, the actuator 811b may be coupled to a housing portion of the haptic mouse 801 other than a rubber foot and used to provide ultrasonic vibrations to adjust an amount of the housing that contacts the surface 823. By way of another example, in some implementations, the rubber foot may be utilized without the actuator 811b. By way of still another example, in various implementations, the haptic mouse 801 may alter friction between the haptic mouse 801 (such as the housing of the haptic mouse 801) and the user's hand rather than, or in addition to, alter friction between the housing of the haptic mouse 801 and the surface 823. Various configurations are possible and contemplated.

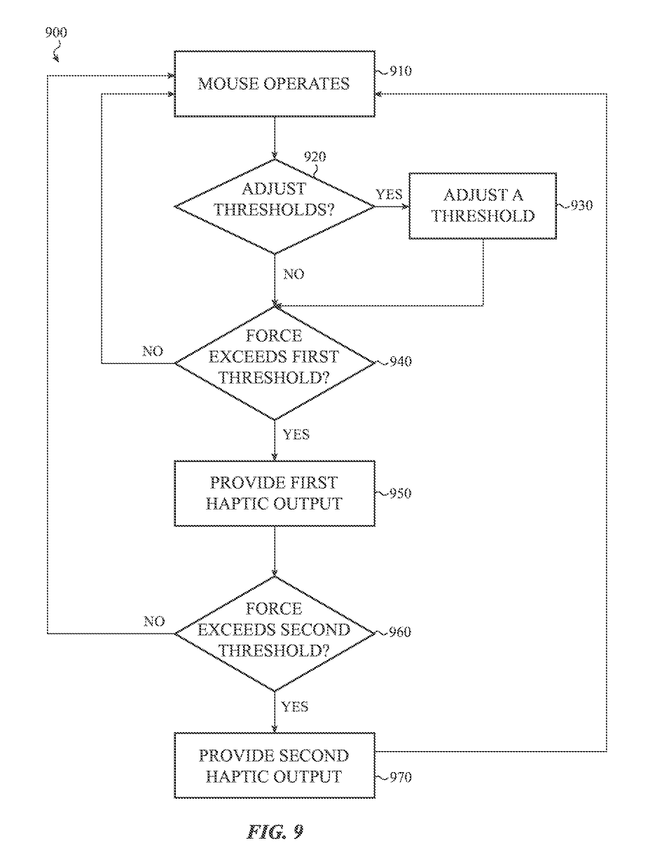

FIG. 9 depicts a flow chart illustrating a first example method 900 for providing output via a haptic mouse. This example method 900 may be performed by one or more of the haptic mice of FIGS. 1-8C.

At 910, a haptic mouse operates. The flow proceeds to 920 where the haptic mouse determines whether or not to adjust one or more force thresholds the haptic mouse evaluates to determine whether or not input is received via one or more force sensors. The haptic mouse may determine to adjust one or more force thresholds based on user input, a changed status of the haptic mouse, instructions from an electronic device with which the haptic mouse communicates, a changed status of the electronic device, and so on. If so, the flow proceeds to 930 where the haptic mouse adjusts the threshold before the flow proceeds to 940. Otherwise, the flow proceeds directly to 940.

At 940, the haptic mouse determines whether or not a first force threshold related to one or more force sensors is exceeded. If so, the flow proceeds to 950. Otherwise, the flow returns to 910 and the haptic mouse continues to operate.

At 950, after the haptic mouse determines that a first force threshold related to one or more force sensors is exceeded, the haptic mouse provides a first haptic output. The first haptic output may include a vibration provided via a surface of the haptic mouse, movement of a first portion of the haptic mouse with respect to a second portion to tangentially deflect skin or alter hand posture of a user's hand, altering friction between the haptic mouse and a surface on which the haptic mouse is operable to move, expansion of a portion of the haptic mouse, and so on. The flow then proceeds to 960.

At 960, the haptic mouse determines whether or not a second force threshold related to one or more force sensors is exceeded. The second force threshold may be greater than the first force threshold. If so, the flow proceeds to 970. Otherwise, the flow returns to 910 and the haptic mouse continues to operate.

At 970, after the haptic mouse determines that a second force threshold related to one or more force sensors is exceeded, the haptic mouse provides a second haptic output before the flow returns to 910 and the haptic mouse continues to operate. The second haptic output may include a vibration provided via a surface of the haptic mouse, movement of a first portion of the haptic mouse with respect to a second portion to tangentially deflect skin or alter hand posture of a user's hand, altering friction between the haptic mouse and a surface on which the haptic mouse is operable to move, expansion of a portion of the haptic mouse, and so on.

Although the example method 900 is illustrated and described as including particular operations performed in a particular order, it is understood that this is an example. In various implementations, various orders of the same, similar, and/or different operations may be performed without departing from the scope of the present disclosure.

For example, the example method 900 is illustrated and described as determining whether or not to adjust force thresholds before determining whether or not a first force threshold is exceeded. However, in various implementations, the haptic mouse may determine whether or not to adjust force thresholds at any time and may not determine whether or not to adjust force thresholds prior to determining whether or not a first force threshold is exceeded.

By way of another example, the example method 900 is illustrated and described as evaluating whether or not first and second force thresholds are exceeded and correspondingly providing first and second haptic outputs. However, in various implementations, the haptic mouse may evaluate whether any number of force thresholds are exceeded and correspondingly provide any number of haptic outputs.

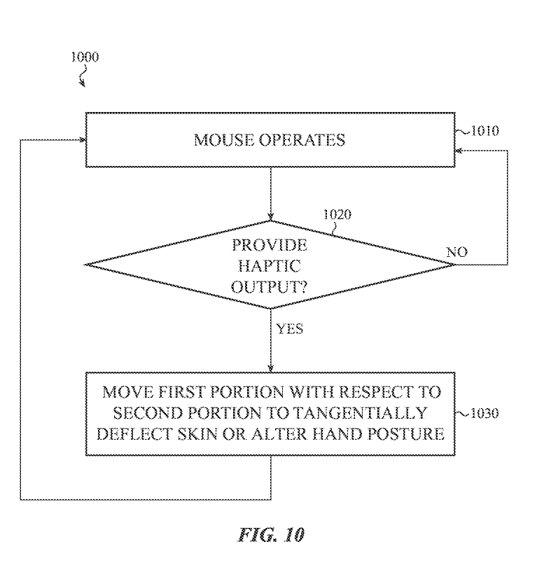

FIG. 10 depicts a flow chart illustrating a second example method 1000 for providing output via a haptic mouse. This example method 1000 may be performed by one or more of the haptic mice of FIGS. 1 and 4-7B.

At 1010, a haptic mouse operates. The flow proceeds to 1020 where the haptic mouse determines whether or not to provide haptic output. The haptic mouse may determine to provide haptic output in response to receiving user input, based on a status change of the haptic mouse, based on an instruction received from an electronic device with which the haptic mouse communicates, based on a status change of the electronic device, and so on. If so, the flow proceeds to 1030. Otherwise, the flow returns to 1010 where the haptic mouse continues to operate.

At 1030, after the haptic mouse determines to provide haptic output, the haptic mouse moves a first portion of the haptic mouse with respect to a second portion to tangentially deflect skin or alter hand posture of a user's hand. Such first and second portions may be housing portions, such as a top portion and a bottom portion, side portions, a side portion and a top or bottom portion, and so on.

After the haptic mouse moves the first portion of the haptic mouse, the flow returns to 1010 where the haptic mouse continues to operate.

Although the example method 1000 is illustrated and described as including particular operations performed in a particular order, it is understood that this is an example. In various implementations, various orders of the same, similar, and/or different operations may be performed without departing from the scope of the present disclosure.

For example, the example method 1000 is illustrated and described as providing haptic input by moving a first portion with respect to a second portion to tangentially deflect skin or alter hand posture of a user's hand. However, in various implementations, the haptic mouse may also provide other types of haptic output, such as a vibration provided via a surface of the haptic mouse, altering friction between the haptic mouse and a surface on which the haptic mouse is operable to move, expansion of a portion of the haptic mouse, and so on.

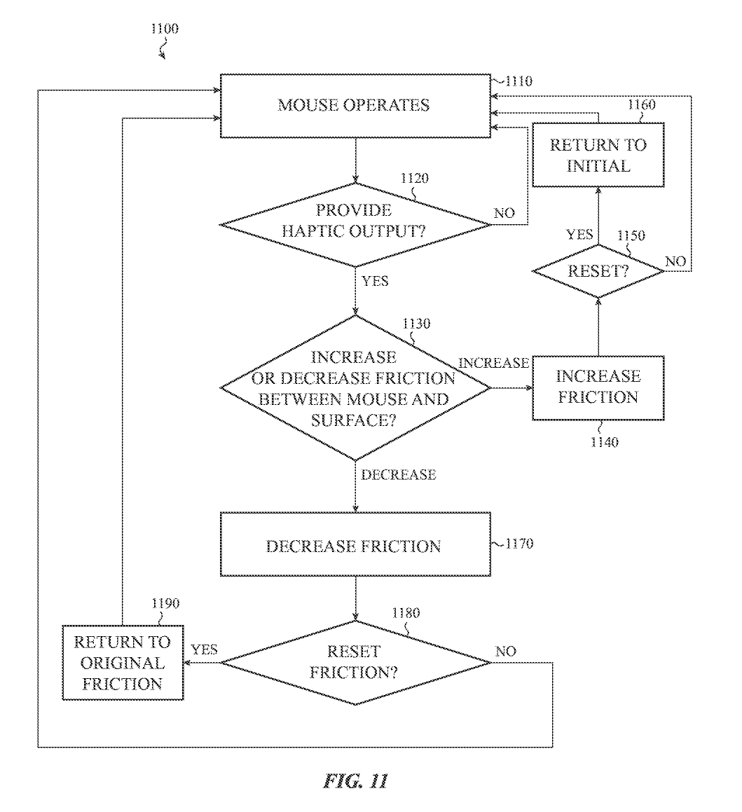

FIG. 11 depicts a flow chart illustrating a third example method for providing output via a haptic mouse. This example method 1100 may be performed by one or more of the haptic mice of FIGS. 1 and 8A-8C.

At 1110, a haptic mouse operates. The flow proceeds to 1120 where the haptic mouse determines whether or not to provide haptic output. If so, the flow proceeds to 1130. Otherwise, the flow returns to 1110 where the haptic mouse continues to operate.

At 1130, after the haptic mouse determines to provide haptic output, the haptic mouse determines whether or not to increase or decrease friction between the haptic mouse and a surface on which the haptic mouse is operable to move to provide the haptic output. If the haptic mouse determines to increase friction, the flow proceeds to 1140. Otherwise, the flow proceeds to 1170.

At 1140, after the haptic mouse determines to increase friction, the haptic mouse increases the friction using a friction adjustment mechanism. The friction adjustment mechanism may be operable to alter friction by adjusting an amount of a material in contact with the surface. Such a friction adjustment mechanism may include a rubber foot having a variable surface area that contacts the surface and is operable to extend from a housing of the haptic mouse and retract into the housing. Such a friction adjustment mechanism may also include an actuator operable to provide ultrasonic or other vibrations to a portion of the housing of the haptic mouse that contacts the surface where increasing a frequency of the vibration decreases friction and decreasing the frequency of the vibration increases friction. The flow may then proceed to 1150.

Although the above describes adjusting friction using ultrasonic vibrations, it is understood that this is an example. In some implementations, electrostatic forces between the between the haptic mouse and the surface may be manipulated to alter friction.

At 1150, the haptic mouse may determine whether or not to reset the friction adjustment mechanism to an original friction level at which the haptic mouse operated prior to the increased friction. If so, the flow proceeds to 1160 where the haptic mouse resets the friction before the flow returns to 1110 where the haptic mouse continues to operate. Otherwise, the flow returns to 1110 directly where the where the haptic mouse continues to operate.

At 1170, after the haptic mouse determines to decrease friction, the haptic mouse decreases the friction using the friction adjustment mechanism. The flow may then proceed to 1180 where the haptic mouse may determine whether or not to reset the friction adjustment mechanism to the original friction level at which the haptic mouse operated prior to the decreased friction. If so, the flow proceeds to 1190 where the haptic mouse resets the friction before the flow returns to 1110 where the haptic mouse continues to operate. Otherwise, the flow returns to 1110 directly where the where the haptic mouse continues to operate.

Although the example method 1100 is illustrated and described as including particular operations performed in a particular order, it is understood that this is an example. In various implementations, various orders of the same, similar, and/or different operations may be performed without departing from the scope of the present disclosure.

For example, the example method 1100 is illustrated and described as providing haptic input by altering friction between the haptic mouse and a surface on which the haptic mouse is operable to move. However, in various implementations, the haptic mouse may also provide other types of haptic output, such as a vibration provided via a surface of the haptic mouse, moving a first portion with respect to a second portion to tangentially deflect skin or alter hand posture of a user's hand, expansion of a portion of the haptic mouse, and so on.

By way of another example, the example method 1100 is illustrated and described as the haptic mouse being operable to both increase and decrease friction between the haptic mouse and the surface. However, in various implementations, the haptic mouse may be operable to increase or decrease the friction without being operable to do both and the function the haptic mouse is not capable of performing may not be performed.

Although the present disclosure is illustrated and discussed in the context of a haptic mouse, it is understood that these are examples. In various implementations, other haptic input devices other than haptic mice that are grasped by one or more hands of a user may be implemented using techniques of the present disclosure, such as haptic track ball devices, graspable or other track pads, and so on. As such, haptic input devices are configured to be grasped by a user, predictions may be made as to where various portions of a user's hand may be during use, allowing for more directed haptic output. Such a grasped configuration may also enable more of a user's hand to be affected than non-grasped configurations as more of the user's hand may be in contact with the haptic input device due to the grasp.

As described above and illustrated in the accompanying figures, the present disclosure relates to a haptic mouse or other graspable input device. The haptic mouse is configured with components that provide a variety of different haptic outputs to a user. Such haptic outputs may include high frequency/low displacement vibrations provided through one or more housings or other portions, portions that move with respect to other portions to tangentially deflect skin and/or alter a hand posture of the user's hand, friction adjusted between the haptic mouse and a surface on which the haptic mouse moves, expansion or contraction of one or more portions, and so on. As such, the user's experience using the haptic mouse may be enriched by allowing more information to be provided to the user and/or via a variety of different ways.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A haptic input device, comprising:
a housing, comprising:
a first housing portion; and
a second housing portion coupled to the first housing portion; and
an actuator coupled to the first housing portion or the second housing portion; wherein
the actuator is operable to provide haptic output by moving the first housing portion with respect to the second housing portion so as to tangentially displace skin or alter hand posture of a user's hand.

2. The haptic input device of claim 1, further comprising:
an additional actuator coupled to the first housing portion or the second housing portion;
wherein the additional actuator is operable to provide an additional haptic output by transmitting a vibration to the user's hand via one of the first housing portion or the second housing portion.

3. The haptic input device of claim 1, further comprising:
an expansion mechanism coupled to at least one of the first housing portion or the second housing portion;
wherein the expansion mechanism is operable to provide an additional haptic output by expanding an area of the first housing portion or the second housing portion.

4. The haptic input device of claim 3, wherein the expansion mechanism comprises an air chamber.

5. The haptic input device of claim 3, wherein the expansion mechanism is operable to expand:
a first area of the first housing portion in a first direction and;
a second area of the second housing portion in a second direction.

6. The haptic input device of claim 1, wherein the first housing portion and the second housing portion are configured to simultaneously contact the user's hand during the haptic output.

7. The haptic input device of claim 1, wherein the actuator is operable to move the first housing portion with respect to the second housing portion so as to alter a position of a first finger of the user's hand with respect to a second finger of the user's hand.

8. A haptic mouse, comprising:
a controller;
a force sensor coupled to the controller; and
an actuator coupled to the controller;
wherein the controller is operable to:
determine an amount of force exerted on the haptic mouse based on a signal received from the force sensor;
simulate a mouse click by providing a haptic output via the actuator if the amount of the force exceeds a threshold; and
adjust the threshold upon receiving a threshold modification instruction.

9. The haptic mouse of claim 8, wherein the controller receives the threshold modification instruction in response to:
an indication from a user to modify the threshold; or
a status change of an electronic device with which the haptic mouse communicates.

10. The haptic mouse of claim 8, wherein the controller is operable to:
simulate a first mouse click by providing a first haptic output via the actuator if the amount of the force exceeds a first threshold; and
simulate a second mouse click by providing a second haptic output via the actuator if the amount of the force exceeds a second threshold.

11. The haptic mouse of claim 8, further comprising a housing coupled to the actuator; wherein the actuator is operable to provide:
a first vibration via a first area of the housing; and
a second vibration via a second area of the housing.

12. The haptic mouse of claim 11, wherein the actuator comprises:
a first actuator operable to provide the first vibration; and
a second actuator operable to provide the second vibration;
the haptic mouse further comprising a dampener that is:
coupled to the housing between the first actuator and the second actuator;
operable to shield the first area from the second vibration; and
operable to shield the second area from the first vibration.

13. The haptic mouse of claim 8, wherein the simulating the mouse click comprises simulating compression of a dome switch.

14. The haptic mouse of claim 8, wherein the force sensor and the actuator are a single piezoelectric element that is operable to:
produce a signal indicative of the amount of force exerted on the piezoelectric element when the force is exerted on the piezoelectric element; and
produce the haptic output when a voltage is applied to the piezoelectric element.

15. A haptic mouse, comprising:
a housing;
a friction adjustment mechanism coupled to the housing operable to alter friction between the housing and a surface by adjusting an amount of a material in contact with the surface; and
a controller coupled to the friction adjustment mechanism;
wherein the controller is operable to provide a haptic output by signaling the friction adjustment mechanism.

16. The haptic mouse of claim 15, wherein the friction adjustment mechanism includes a rubber foot having a variable surface area that contacts the surface.

17. The haptic mouse of claim 16, wherein a portion of the rubber foot is operable to extend from the housing and retract into the housing.

18. The haptic mouse of claim 15, wherein the friction adjustment mechanism includes an actuator operable to provide a vibration to a portion of the housing that contacts the surface.

19. The haptic mouse of claim 18, wherein the vibration is an ultrasonic vibration.

20. The haptic mouse of claim 18, wherein the actuator:
increases a frequency of the vibration to decrease the friction; and
decreases the frequency of the vibration to increase the friction.
